(19) United States
(12) Patent Application Publication
(10) Pub. No.: US 2015/0074092 A1
(43) Pub. Date: Mar. 12, 2015

(54) Method of Ranking Place Names, System of Ranking Place Names, and Non-Transitory Computer-Readable Storage Medium Thereof

(71) Applicant: Institute for Information Industry, Taipei (TW)

(72) Inventors: Ping-I Chen, Taipei City (TW); Tai-Chun Wang, New Taipei City (TW); Chen-Wei Chung, Zhongli City, Taoyuan County (TW)

(73) Assignee: Institute for Information Industry, Taipei (TW)

(21) Appl. No.: 14/065,544

(22) Filed: Oct. 29, 2013

(30) Foreign Application Priority Data
Sep. 6, 2013 (TW) 102132212

(51) Int. Cl. G06F 17/30

(52) U.S. Cl. CPC G06F 17/3053
USPC 707/723

(57) ABSTRACT

A method of ranking place names is disclosed. The method of ranking place names includes providing a plurality of place names, getting a plurality of searching result amounts of place names based on these place names, determining a relative degree between every two place names based on the searching result amounts of the place names, determining a starting place name of the place name ranking based on the relative degree between every two place names, calculating the intersection degree between these place names, and determining the ranking of these place names based on the searching result amounts of the place names, the relative degree between every two place names, the intersection degree between these place names, and the starting place name.

### RELATED APPLICATIONS

This application claims priority to Taiwan Application Serial Number 102132212, filed Sep. 6, 2013, which is herein incorporated by reference.

### BACKGROUND

1. Field of Invention

The present invention relates to a technology of ranking place names. More particularly, the present invention relates to a method of ranking place names for tourist spots, a system of ranking place names for tourist spots, and a non-transitory computer-readable storage medium thereof.

2. Description of Related Art

Recently, there are many tour planning websites which provide users guidelines for planning the schedule of a tour. After a user sets the tour regions and the transport mode, the website will create one or several tour suggestions according to the user's setting. However, there are so many tour planning websites, the good and bad are intermingled, and some data may be incorrect. When the user wants to plan a tour to the place where he has never been, he may not determine whether the tour suggestion is proper or not, for example, the transport time between two tourist spots or the smooth of the schedule.

Some tour planning websites may rank the tourist spots in a region according to the distance between every two places so that a customized tour may be provided. Thus, even the customized tour may help a user to make a decision of various tour suggestions, it may not provide a schedule cover overall tour.

The ranking method of tourist spots in current tour planning websites is based on the tour information in the database of the website respectively and is utilized to provide users with tour plans. Even the tour suggestion is provided, it may not match the requirements from users. Therefore, it is an important problem to provide a customized tour according to the analysis of the information from various websites on the internet and the proper ranking of the place names based on others' touring experience. The problem desiderates to be improved in this field, either.

### SUMMARY

One aspect of this invention is to provide a method of ranking place names, a system of ranking place names, and a non-transitory computer-readable storage medium thereof to solve the problem mentioned above.

In one embodiment of this invention, the method of ranking place names includes: (a). providing plural place names; (b). getting plural searching result amounts of place names based on these place names; (c). determining a relative degree between every two place names based on the searching result amounts of the place names; (d). determining a starting place name of the place name ranking based on the relative degree between every two place names; (e). calculating the intersection degree between these place names; (f). determining the ranking of these place names based on the searching result amounts of the place names, the relative degree between every two place names, the intersection degree between these place names, and the starting place name.

In one embodiment of this invention, the system of ranking place names include: a place name registor, a processor registor and a processing module. The place name registor is utilized to store plural place names. The processing module is utilized to get plural searching result amounts of place names based on these place names and store the searching result amounts into the processor registor. The processing module determines a relative degree between every two place names based on the searching result amounts of the place names and stores relative degree into the processor registor. Then, a starting place name of the place name ranking is determined by the relative degree between every two place names, the intersection degree between the place names is calculated and the ranking of these place names is determined by the searching result amounts of the place names, the relative degree between every two place names, the intersection degree between these place names, and the starting place name.

In one embodiment of this invention, a non-transitory computer-readable storage medium is provided to store a computer program for performing a method of ranking place names. The method includes: storing plural place names; getting plural searching result amounts of place names based on these place names; determining a relative degree between every two place names based on the searching result amounts of the place names; determining a starting place name of the place name ranking based on the relative degree between every two place names; calculating the intersection degree between these place names; and determining the ranking of these place names based on the searching result amounts of the place names, the relative degree between every two place names, the intersection degree between these place names, and the starting place name.

To sum up, comparing with the prior art, the technology of this invention has significant advantages and effects. The technology is improved and may be utilized widely in the industry according to this invention. The advantage should be emphasized is that a better customized tour may be provided according to the analysis of a great deal of tour information from the internet and the proper ranking of the place names based on others' touring experience.

These and other features, aspects, and advantages of the present invention will become better understood with reference to the following description, accompanying drawings and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a flow chart of a method of ranking place names according to one embodiment of this invention;

FIG. 2 is a schematic of a method of ranking place names according to one embodiment of this invention;

FIG. 3 is another schematic of a method of ranking place names according to one embodiment of this invention;

FIG. 4 is a flow chart showing one step of the method of ranking place names in FIG. 1 according to this invention;

FIG. 5 is a schematic of a method of ranking place names in FIG. 4 according to this invention; and

FIG. 6 is a block diagram of a method of ranking place names according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts. Further, the foregoing has outlined features of several embodiments so that those skilled in the art can better understand the detailed description that follows. Those skilled in the art should appreciate that they can readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they can make various changes, substitutions and alterations herein without departing from the spirit and scope of the present disclosure. On the other way, the well-known components or steps will not be described in the embodiments to prevent this invention from unnecessary limits.

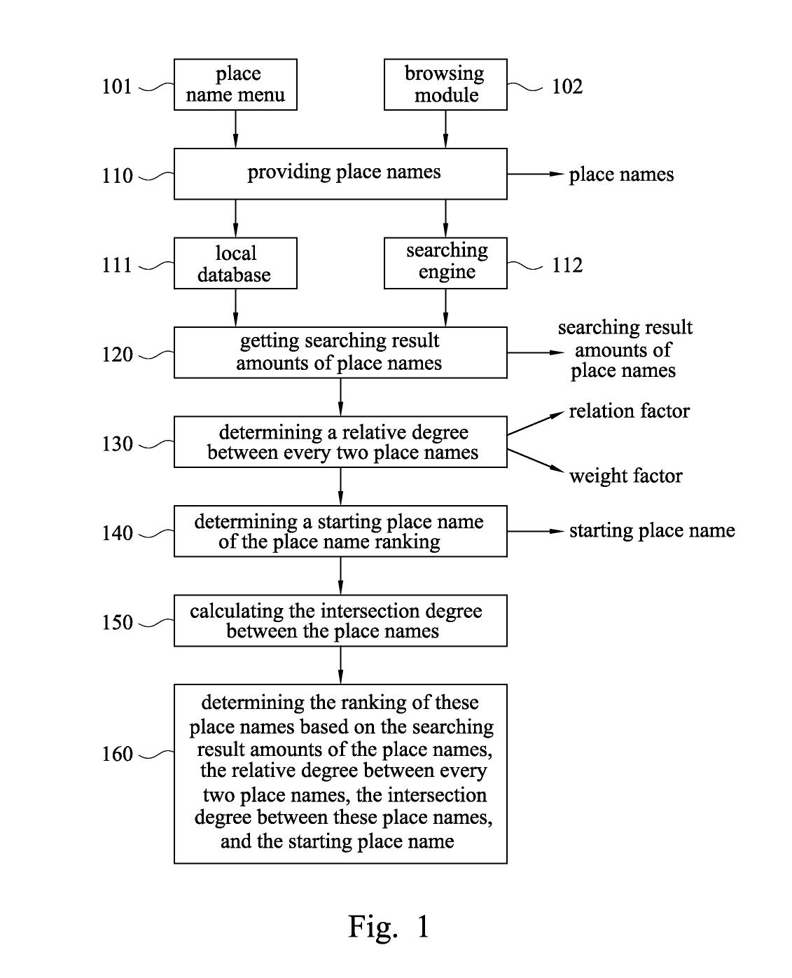

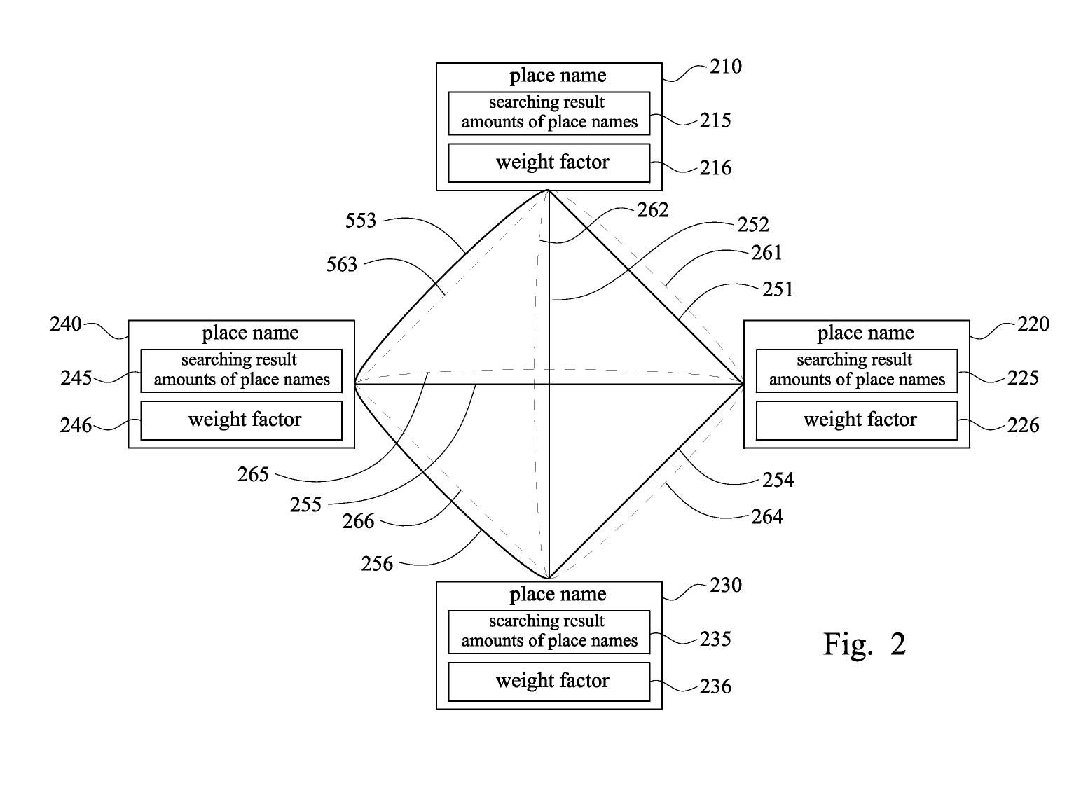

FIG. 1 is a flow chart of a method of ranking place names according to one embodiment of this invention. As shown in FIG. 1, the method of ranking place names includes steps 110-160. It should be understood that unless specifically indicating the order, the steps in this embodiment may be proceeded in any sequence, simultaneously or partially simultaneously as required. In step 110, plural place names are provided first. The place names may be stored in a place name registor of a physical database or a cloud database. For example, the physical database may be a dynamic random access memory (DRAM), a hard disk or a memory card, while the cloud database may be an online hard drive or a cloud searching system (e.g. Google searching engine). In some embodiment, the place names may be the tourist spots of the user's plan. These place names may be ranked by the ranking method of this invention so that a better tour suggestion is provided to the user. FIG. 2 is a schematic of a method of ranking place names according to one embodiment of this invention. As shown in FIG. 2, place names 210, 220, 230, 240 are the stored place names (e.g. tourist spots), wherein the amount of the place names should be determined as required.

Referring to FIG. 1, in one embodiment, as step 101 shown, the user may select the place names from a menu consisting of plural tourist spots, or input the place name which is not in the menu by manual operation. In another embodiment, as step 102 shown, the place name may be collected from detecting user's operation in a specific electronic book or website by a browsing module (such as input interface, for instance, touching device, eye-control device or mouse). In more details, the place names may be retrieved from the detected operation by a conventional technology of keyword capture (e.g. Chinese Knowledge Information Processing Group, CKIP). The place names with higher reading frequency may be captured during the user visits the website consisting plural place names. The amount of captured place names may be determined as required. It should be understood that any generation method of the place names mentioned above is not preferred and is not tended to limit this invention. One person skilled in the art may flexibly select any implement method of the step above as required.

Because more people like to post their travel notes on the internet or social networking sites, tour websites may introduce the tourist spots based on a specific region or a specific tour period, and some travel agencies may post some tour packages on websites for sale, the place names related to the stored place names may collected from the travel notes, tourist spots introductions, and the tour packages. In step 120, plural searching result amounts of place names are generated based on these place names. Each of the place names has a searching result amount respectively. When the searching result amount of a place name is great, it indicates that the place name may be found in many websites. However, the website related to the stored place name may just describe the stored place name once or may contain other place names. When the other place names in the website are different from the stored place name, the website has less reference value for the ranking method of this invention. Conversely, when the other place names in the website are the same as one or more of the stored place names, the website has reference value for the ranking method of this invention. As shown in FIG. 2, place names 210, 220, 230, 240 are selected to be ranked. The searching result amounts of place names are generated based on the place names 210, 220, 230, 240. That is, the searching result amount 215 is generated based on the place names 210. The searching result amount 225 is generated based on the place names 220. The searching result amount 235 is generated based on the place names 230. The searching result amount 245 is generated based on the place names 240. When the travel notes, tourist spots introductions, and the tour packages of the websites or social networking sites mention more information about the place names 210, 220, 230, 240, the respective searching result amounts 215, 225, 235, 245 increase.

As shown in FIG. 1, in one embodiment, plural searching result amounts of place names may be gotten from a local database, and each of the place names has a searching result amount respectively. In step 111, the local database includes plural searching result amounts of place names, and the searching result amounts are updated regularly. The supervisor of the local database may add and update the place names and the respective searching result amounts irregularly. In another embodiment, as step 112 shown, plural searching result amounts of place names may be gotten from a searching engine (e.g. Google), wherein each of the place names has a searching result amount respectively. The supervisor of the local database may update the local database in step 111 simultaneously by searching the place name and the respective searching result amount. It should be understood that any method mentioned above is not preferred and is not tended to limit this invention. One person skilled in the art may flexibly select any implement method of the step above as required.

Referring to FIG. 1 and FIG. 2, in step 130, a relative degree between every two place names is determined by the searching result amounts of the place names and plural relation factors of place names may be calculated by the relative degree between every two place names. Place names 210, 220, 230, 240 are selected to be ranked, and have searching result amounts 215, 225, 235, 245 respectively. Every two place names (for example, place names 210 and 220, place names 210 and 230, place names 210 and 240, place names 220 and 230, place names 220 and 240, place names 230 and 240) are combined to a new keyword and has a searching result amount of two place names (not shown) respectively. Based on searching result amounts 215, 225, 235, 245 and the searching result amounts of two place names, plural relation factors of place names 251, 252, 253, 254, 255, 256 may be calculated by the algorithm of Normalized Google Distance and indicate the relationship between every two place names. When the relationship between two place names is closer, the relation factor is increased. It also means that these two place names appear simultaneously and frequently in the websites, for example, the travel notes, tourist spots introductions, and the tour packages of the websites or social networking sites. For example, the two place names may be adjacent tourist spots, be in the same region, have similar characteristic and so on.

Based on the relation factors of place names 251, 252, 253, 254, 255, 256, the relationship between the place names 210, 220, 230, 240 may be analyzed more exactly by the algorithm of Associated PageRank to evaluate the relation weight of the place names 210, 220, 230, 240. Then, the weight factors of the place names 216, 226, 236, 246 are generated respectively. When the weight factor is greater, the respective place name appears simultaneously with one or more other evaluated place names and more easily in the travel notes, tourist spots introductions, and the tour packages of the websites or social networking. In step 140, a starting place name of the place name ranking is determined by the relative degree between every two place names. That is, the place name corresponding to the greatest one of the weight factors of the place names 216, 226, 236, 246 is determined as the starting place name of the place name ranking. For example, when the weight factor 216 is the greatest one of the weight factors 216, 226, 236, 246, the place name 210 is the starting place name of the place name ranking.

In the travel notes, tourist spots introductions, and the tour packages of the websites or social networking sites, there are some other place names related to the place names 210, 220, 230, 240. They may be not limited to the stored place names in step 110. According to the place names 210, 220, 230, 240 and other related place names, the relation factors of every two place names (including the place names 210, 220, 230, 240 and other related place names) may be calculated by the searching result amounts 215, 225, 235, 245 of the place names 210, 220, 230, 240 and those of other related place names. In order to get the place names more related to the place names 210, 220, 230, 240, a threshold relation factor may be set as required. Any couple place names having a relation factor higher than the threshold relation factor is collected to an intersection list related to the place names 210, 220, 230, 240. The intersection list related to the place names 210, 220, 230, 240 may help to confirm the relationship between the place names 210, 220, 230, 240.

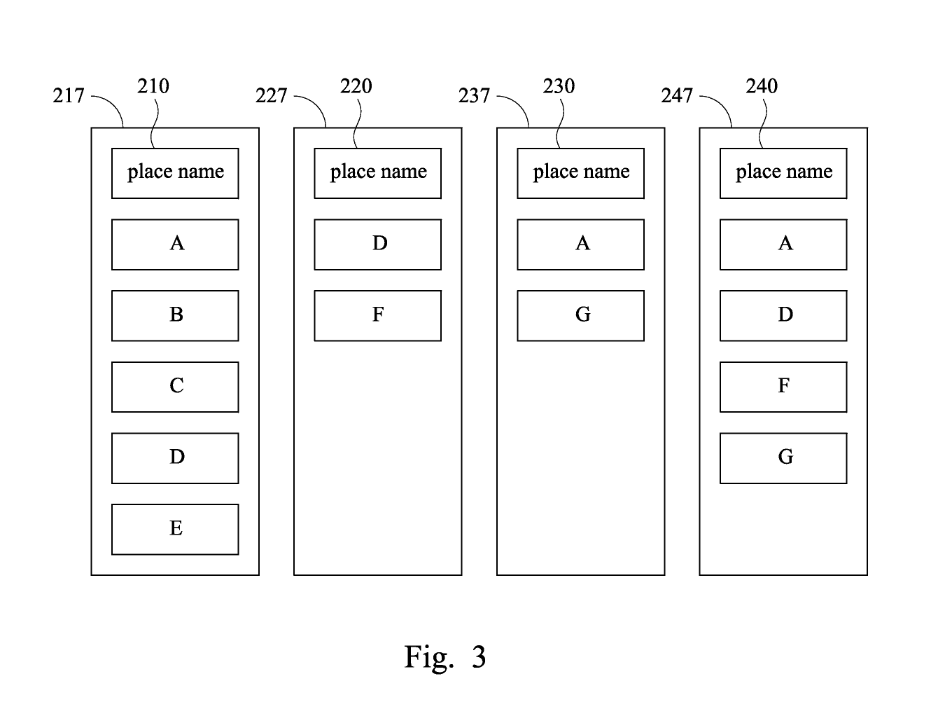

FIG. 3 is another schematic of a method of ranking place names according to one embodiment of this invention. As shown in FIG. 3, the place names 210, 220, 230, 240 have the intersection lists 217, 227, 237, 247 respectively. The intersection list 217 includes at least one place name highly related to the place name 210. For example, the intersection list 217 includes place names A, B, C, D, E, wherein these place names may be some of the place names 210, 220, 230, 240 and other related place names. Similarly, the intersection lists 227, 237, 247 include at least one place name highly related to the place names 220, 230, 240 respectively. The intersection degree between the place names 210, 220, 230, 240 may be calculated by the intersection lists 217, 227, 237, 247. As shown in FIG. 1 and FIG. 3, in Step 150, the intersection degree between the place names is calculated. For example, the place names A, B, C, D, E are highly related to the place name 210 according to the intersection list 217, and the place names D, F are highly related to the place name 220 according to the intersection list 227. The intersection lists 217 and 227 include place names A, B, C, D, E, F (six place names), and have a common place name D (one place name). Therefore, the intersection degree between place names 210 and 220 is defined as the ratio between the quantity of the common place name and the quantity of the total place names, that is, 1/6. Similarly, the intersection degree between place names 210 and 230 is 1/6; the intersection degree between place names 210 and 240 is 2/7; the intersection degree between place names 220 and 230 is 0/4; the intersection degree between place names 220 and 240 is 2/4 and the intersection degree between place names 230 and 240 is 2/4.

As shown in FIG. 1, FIG. 2, and FIG. 3, in step 160, the ranking of these place names is determined by the searching result amounts of the place names 215, 225, 235, 245, the relative degree between every two place names, the intersection degree between these place names, and the starting place name. Regarding the place names 210, 220, 230, 240, the place name with high searching result amount indicates that the place name appears in the travel notes, tourist spots introductions, and the tour packages of the websites or social networking sites more frequently. Thus, the place name may be a hot tourist spot, have distinguishing feature or be highly promoted. The ranking of the place names 210, 220, 230, 240 should consider the searching result amounts 215, 225, 235, 245. When the relationship between two place names is closer, the relation factor is increased. It also means that these two place names appear simultaneously and frequently in the websites, for example, the travel notes, tourist spots introductions, and the tour packages of the websites or social networking sites. Therefore, the ranking of the place names 210, 220, 230, 240 should consider the relation factors of place names 251, 252, 253, 254, 255, 256, too. According to the weight factors 216, 226, 236, 246 of the place names 210, 220, 230, 240, the starting place name of the place name ranking is determined, that is, one of the place names 210, 220, 230, and 240. The intersection degree of the place names 210, 220, 230, 240 may help to confirm the relationship between the place names 210, 220, 230, 240 in more detail. Thus, the ranking of the place names 210, 220, 230, 240 should consider the intersection degree between the place names. The step 160 in FIG. 1 is explained in more detail as below.

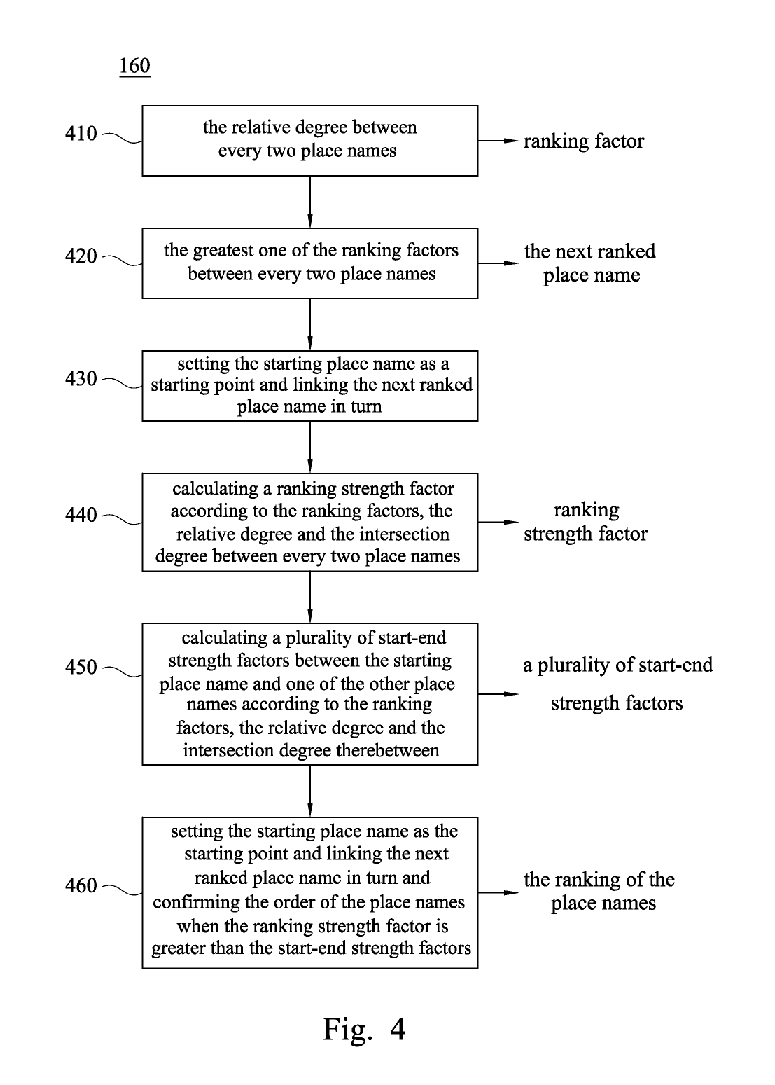

FIG. 4 is a flow chart showing one step 160 of the method of ranking place names in FIG. 1 according to this invention. As shown in FIG. 1-FIG. 4, in step 410, the ranking factor between every two place names is calculated by the relative degree between every two stored place names. The starting place name of the place name ranking is determined in step 140. For example, if the place name 210 is the starting place name, the relation factor 251 and the weight factors 216 and 226 may be calculated by the relation degree between the place names 210 and 220. According to the relation factor 251 and the weight factor 226 of the place name 220 (from place name 210 to 220), the ranking factor 261 between the place names 210 and 220 may be calculated. Similarly, the ranking factor 262 between the place names 210 and 230 may be calculated by the relative degree between the place names 210 and 230; the ranking factor 263 between the place names 210 and 240 may be calculated by the relative degree between the place names 210 and 240. Accordingly, the ranking factors 261, 262, 263 from place name 210 to place names 220, 230, 240 are generated. Comparing the ranking factors 261, 262, 263, the place name with the greatest ranking factor is the next rank from the place name 210. For example, if the ranking factor 261 is the greatest one of the ranking factors 261, 262, 263, the place name 220 is the next one from the place name 210 in the ranking sequence.

In step 420, the next ranked place name is determined by selecting the place name with the greatest ranking factor of the ranking factors between every two place names. For example, if the ranking factor 261 is the greatest one of the ranking factors 261, 262, 263, it indicates that the order from the place name 210 to the place name 220 is the best, after considering the relative degrees between the place name 210 and place names 220, 230, 240 respectively. Therefore, the place name 220 is determined as the next ranked place from the place name 210. Similarly, in step 410, the ranking factor 264 between the place names 220 and 230 may be calculated by the relative degree between the place names 220 and 230; the ranking factor 265 between the place names 220 and 240 may be calculated by the relative degree between the place names 220 and 240. Comparing the ranking factors 264, 265, the place name with the greatest ranking factor is the next rank from the place name 220. In another embodiment, if the ranking factor 262 is the greatest one of the ranking factors 261, 262, 263, it indicates that the order from the place name 210 to the place name 230 is the best, after considering the relative degrees between the place name 210 and place names 220, 230, 240 respectively. Therefore, the place name 230 is determined as the next ranked place from the place name 210. In step 410, the ranking factor 264 between the place names 230 and 220 may be calculated by the relative degree between the place names 230 and 220; the ranking factor 266 between the place names 230 and 240 may be calculated by the relative degree between the place names 230 and 240. Comparing the ranking factors 264, 266, the place name with the greatest ranking factor is the next rank from the place name 230. Similarly, from the starting place name, the next ranked place name may be determined in turn. In this embodiment, because the ranking is consisted of four place names 210, 220, 230, and 240, the last ranked place name is the end place name.

In step 430, the starting place name as the starting point, the next ranked place name is linked in turn. For example, if the place name 210 is the starting place name, according to the ranking factors 261, 262, 263, 264, 265, 266, the place name 220 is determined as the next ranked place name from the place name 210; the place name 230 is determined as the next ranked place name from the place name 220 and the place name 240 is determined as the next ranked place name from the place name 230. Thus, the place name 210, 220, 230 and 240 are linked in turn.

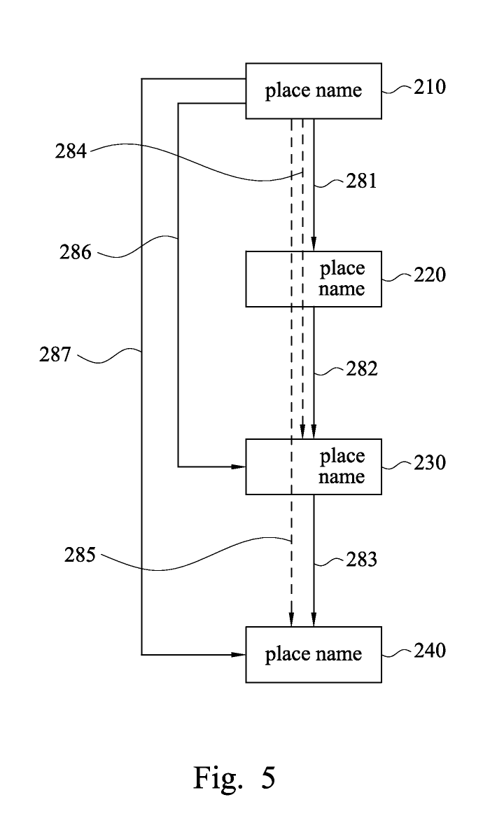

FIG. 5 is a schematic of a method of ranking place names in FIG. 4 according to this invention. As shown in FIG. 4 and FIG. 5, in Step 440, according to the ranking factor, the relative degree and the intersection degree between every two adjacent place names, the ranking strength factors may be calculated. For example, the place name 210 as the starting place name, the place name 220 is the next ranked place name from the place name 210. According to the ranking factor 261 between place names 210 and 220, the relation factor 251 calculated for the relation degree of the place names 210 and 220, and the intersection degree 1/6 of the place names 210 and 220 as mentioned above, the ranking strength factor 281 from the place name 210 to the place name 220 may be calculated. Similarly, the ranking strength factor 282 from the place name 220 to the place name 230 may be calculated and the ranking strength factor 283 from the place name 230 to the place name 240 may be calculated. The ranking strength factor 284 form the place name 210 through the place name 220 to the place name 230 is the average of the ranking strength factors 281 and 282. The ranking strength factor 285 form the place name 210 through the place names 220, 230 to the place name 240 is the average of the ranking strength factors 281, 282, and 283.

In Step 450, according to the ranking factor, the relative degree and the intersection degree between the starting place name (e.g. place name 210) and one of the other place names (e.g. place names 220, 230, 240), plural start-end strength factors between every two place names may be calculated. As mentioned above, the place name 210 as the starting place name, the start-end strength factor 286 from the place name 210 directly to the place name 230 and bypassing the place name 220 may be calculated. The start-end strength factor 287 from the place name 210 directly to the place name 240 and bypassing the place names 220, 230 may be calculated.

In Step 460, when the ranking strength factor is greater than the start-end strength factor, the starting place name as the starting point, the next ranked place name is linked and the order is confirmed in turn. For example, the place name 210 as the starting place name, the ranking strength factor 284 is from the place name 210 through the place name 220 to the place name 230 and the start-end strength factor 286 is from the place name 210 directly to the place name 230 and bypassing the place name 220. When the ranking strength factor 284 is greater than the start-end strength factor 286, it indicates that the order from the place name 210 through the place name 220 to the place name 230 is better than the order from the place name 210 directly to the place name 230 and bypassing the place name 220. When the ranking strength factor 285 is greater than the start-end strength factor 287, it indicates that the order from the place name 210 through the place names 220, 230 to the place name 240 is better than the order from the place name 210 directly to the place name 240 and bypassing the place names 220, 230. Conversely, when the ranking strength factor is not greater than the start-end strength factor, some of the ranking factors between every two place names may be the same. For example, among the ranking factors 261, 262, 263 from the place name 210 to the place names 220, 230, 240, the ranking factors 261 and 262 are the same and the greatest. Although the place names 220 and 230 are both properly the next ranked place name from the place name 210, the relative degree between the place names 210 and 220 may be different from that between the place names 210 and 230. The relation factors 251 and 252 may be different and the weight factors 216 and 226 may be different, even the ranking factors 261 and 262 are the same. Therefore, the place name 230 may be re-selected as the next ranked place name from the place name 210. Then, according to steps 420-460, the place names are ranked again and confirmed by the ranking strength factor. It should be understood that any example mentioned above is not tended to limit this invention. One person skilled in the art may flexibly select any amount of ranking place names and any implement method of the Step above as required.

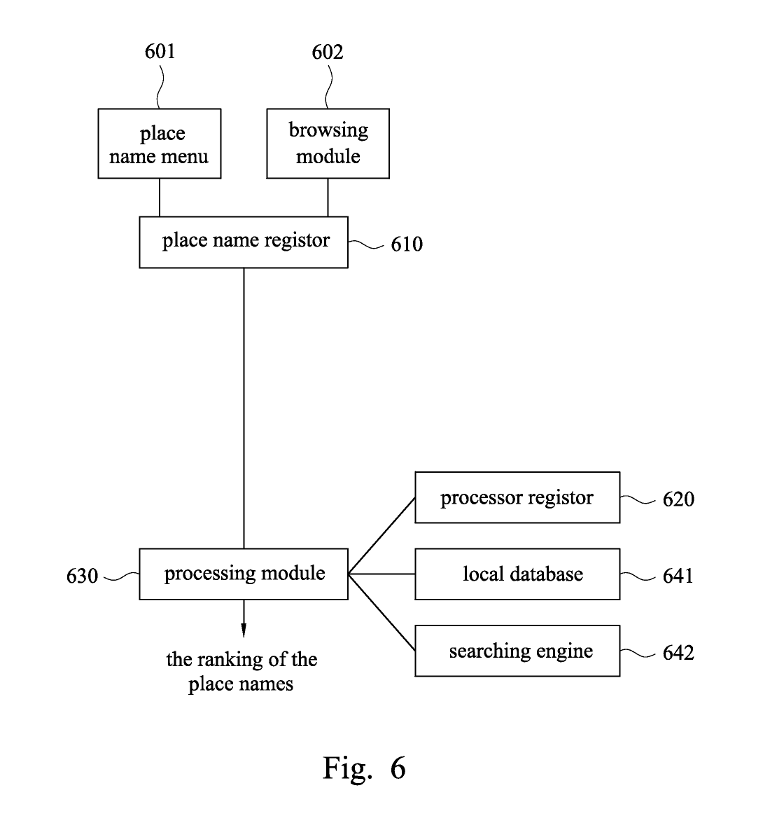

FIG. 6 is a block diagram of a method of ranking place names according to one embodiment of this invention. As shown in FIG. 6, the system of ranking place names include: a place name registor 610, a processor registor 620 and a processing module 630. The place name registor 610 is utilized to store plural place names. In practice, the place name registor 610 may be a device or an apparatus with storage function, such as a physical database or a cloud database. For example, the physical database may be a dynamic random access memory (DRAM), a hard disk or a memory card, while the cloud database may be an online hard drive or a cloud searching system (e.g. Google searching engine). In some embodiment, the stored place names may be the tourist spots of the user's plan. These place names may be ranked by the ranking method of this invention so that a better tour suggestion is provided to the user. As shown in FIG. 2, the place names 210, 220, 230, and 240 are the stored place names wherein the amount of the stored place names may be adjusted as required. The processing module 630 is utilized to get plural searching result amounts of place names 215, 225, 235, 245 based on the place names 210, 220, 230, 240 and store the searching result amounts 215, 225, 235, 245 into the processor registor 620. When the travel notes, tourist spots introductions, and the tour packages of the websites or social networking sites mention more information about the place names 210, 220, 230, 240, the respective searching result amounts 215, 225, 235, 245 are increased. In practice, the processor registor 620 may be a device or an apparatus with storage function, such as a dynamic random access memory (DRAM), a hard disk or a memory card. The processing module 630 may be software, hardware and/or firmware. The software, hardware and/or firmware may be integrated into the central processing unit (CPU). For example, if the major concern is executing speed and precision, the processing module 630 may be preferred hardware and/or firmware basically. If the major concern is the flexibility of design, the processing module 630 may be preferred software basically. Furthermore, software, hardware and firmware may be integrated as the processing module 630. Relative degrees between every two place names of the place names 210, 220, 230, 240 are determined by the searching result amounts of the place names 215, 225, 235, 245 and stores relative degrees into the processor registor 620. In addition to the searching result amounts of the place names 215, 225, 235, 245, every two place names of the place names 210, 220, 230, 240 may be combined to a new keyword and has a searching result amount of two place names (not shown) respectively. Based on searching result amounts 215, 225, 235, 245 and the searching result amounts of two place names, plural relation factors of place names 251, 252, 253, 254, 255, 256 may be calculated. Based on the relation factors of place names 251, 252, 253, 254, 255, 256, the relationship between the place names 210, 220, 230, 240 may be analyzed more exactly by the algorithm of Associated PageRank to evaluate the relation weight of the place names 210, 220, 230, 240. Then, the weight factors of the place names 216, 226, 236, 246 are generated respectively. The place name corresponding to the greatest one of the weight factors of the place names 216, 226, 236, 246 is determined as the starting place name of the place name ranking. The processing module 630 calculates the intersection degree between the place names 210, 220, 230, 240 by the relation factors of place names 251, 252, 253, 254, 255, 256 and the weight factors of the place names 216, 226, 236, 246.

Finally, the processing module 630 determines the ranking of these place names 210, 220, 230, 240 by the searching result amounts of the place names 215, 225, 235, 245, the relation factors of place names 251, 252, 253, 254, 255, 256 calculated from the relative degree between every two place names, the intersection degree between the place names 210, 220, 230, 240, and the starting place name determined by the place name corresponding to the greatest one of the weight factors of the place names 216, 226, 236, 246. The definitions and calculations of the searching result amounts of the place names 215, 225, 235, 245, the relation factors of place names 251, 252, 253, 254, 255, 256 calculated from the relative degree between every two place names, and the intersection degree between the place names 210, 220, 230, 240 are disclosed in the embodiments above.

In one embodiment, as shown in FIG. 6, the place names 210, 220, 230, 240 are selected from the place name menu 601. The user may select the place names from the menu 601 consisting of plural tourist spots, or input the place name which is not in the menu 601 by manual operation. In another embodiment, the place names 210, 220, 230, 240 may be collected from detecting user's operation in a specific electronic book or website by a browsing module 602 (input interface, for instance, touching device, eye-control device or mouse). The implement method and the function of the browsing module 602 are disclosed above. It should be understood that any example mentioned above is not preferred and is not tended to limit this invention. One person skilled in the art may flexibly select any implement method of the place name menu 601 and/or the browsing module 602 as required. The place names 210, 220, 230, 240 are selected for ranking. The searching result amounts of place names 215, 225, 235, 245 are generated based on the place names 210, 220, 230, 240. In one embodiment, the processing module 630 obtains the searching result amounts of place names 215, 225, 235, 245 from a local database 641. In this embodiment, the local database 641 includes plural searching result amounts of many place names, and the searching result amounts are updated regularly. The supervisor of the local database 641 may add and update the place names and the respective searching result amounts irregularly. In practice, the local database 641 may be a storage medium on the local end, such as a hard disk, a Direct Attached Storage (DAS) and so on. The local database 641 may be connected to other storage medium through the internet connection, such as Network Attached Storage (NAS).

In another embodiment, based on the place names 210, 220, 230, 240, the processing module 630 may obtain the searching result amounts of place names 215, 225, 235, 245 from a searching engine 642 (e.g. Google). It should be understood that any example mentioned above is not preferred and is not tended to limit this invention. One person skilled in the art may flexibly select any implement method of the local database 641, the searching engine 642 and getting the searching result amounts of place names 215, 225, 235, 245 as required.

As shown in FIG. 2 and FIG. 5, in one embodiment, based on the place names 210, 220, 230, 240, the processing module 630 calculates the ranking factors 261, 262, 263, 264, 265,266 between every two place names by the weight factors 216, 226, 236, 246 and the relation factors 251, 252, 253, 254, 255, 256. The processing module 630 selects the greatest one of the ranking factors 261, 262, 263, 264, 265, 266 between every two place names and determines the next ranked place name respectively. The starting place name (e.g. the place name 210) as the starting point, the next ranked place name (e.g. the place names 220, 230) is linked in turn. The ranking strength factor 285 is calculated by the ranking factors 261, 262, 263, 264, 265,266 between every two place names, the relation factors 251, 252, 253, 254, 255, 256 and the intersection degree of the place names 210, 220, 230, 240. According to the ranking factors 262, 263 between the starting place name (e.g. the place name 210) and one of the other place names (e.g. the place names 230, 240), the relation factors 252, 253 calculated from the relative degree between the place names 210, 230 and 240 and the intersection degree of the place names 210, 230, 240, the start-end strength factors 286, 287 between every two place names may be calculated. When the ranking strength factor 285 is greater than the start-end strength factor 287, the starting place name (e.g. the place name 210) as the starting point, the next ranked place name (e.g. the place names 220, 230) is linked in turn and the ranking of the place names 210, 220, 230, 240 is confirmed. The implement steps and the method for the processing module 630 are disclosed above.

In practice, the method of ranking place names may be implemented by a network server or a web station. The portion of the function may be implemented in a program stored in a non-transitory computer-readable storage medium (e.g., a floppy disk, a hard disk drive, a Compact Disc (CD), a Digital Video Disk (DVD), a digital tape, a computer memory, etc) so that the computer may read the medium and make a network server or a web station to execute the method of ranking place names.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method of ranking place names comprising:
(a). providing a plurality of place names;
(b). getting a plurality of searching result amounts of place names based on these place names;
(c). determining a relative degree between every two place names based on the searching result amounts of the place names;
(d). determining a starting place name of the place name ranking based on the relative degree between every two place names;
(e). calculating the intersection degree between the place names; and
(f). determining the ranking of these place names based on the searching result amounts of the place names, the relative degree between every two place names, the intersection degree between these place names, and the starting place name.

2. The method of ranking place names of claim 1, wherein the place names are a plurality of tourist spots selected from a place name menu.

3. The method of ranking place names of claim 1, wherein the place names are a plurality of tourist spots detected by a browsing module.

4. The method of ranking place names of claim 1, wherein the step (b) further includes:
getting the searching result amounts of place names based on the place names from a local database, wherein each of the place names has one of the searching result amounts of place names respectively.

5. The method of ranking place names of claim 1, wherein the step (b) further includes:
getting the searching result amounts of place names based on the place names from a searching engine, wherein each of the place names has one of the searching result amounts of place names respectively.

6. The method of ranking place names of claim 1, wherein the step (d) further includes:
calculating a plurality of weight factors of the place names based on the relative degree between every two place names;
setting the place name corresponding to the greatest one of the weight factors of the place names as the starting place name.

7. The method of ranking place names of claim 1, wherein the step (f) further includes:
calculating a plurality of ranking factors between every two place names based on the relative degree between every two place names;
selecting the place name corresponding to the greatest one of the ranking factors between every two place names as the next ranked place name respectively;
setting the starting place name as a starting point and linking the next ranked place name in turn;
calculating a ranking strength factor according to the ranking factors, the relative degree and the intersection degree between every two place names;
calculating a plurality of start-end strength factors between the starting place name and one of the other place names according to the ranking factors, the relative degree and the intersection degree therebetween; and
setting the starting place name as the starting point and linking the next ranked place name in turn and confirming the order of the place names when the ranking strength factor is greater than the start-end strength factors.

8. A system of ranking place names, comprising:
a place name registor utilized to store a plurality of place names;
a processor registor; and
a processing module utilized to get a plurality searching result amounts of place names based on these place names, store the searching result amounts into the processor registor, determine a relative degree between every two place names based on the searching result amounts of the place names, store relative degree into the processor registor, determine a starting place name of the place name ranking based on the relative degree between every two place names, calculate the intersection degree between the place names and determine the ranking of these place names by the searching result amounts of the place names, the relative degree between every two place names, the intersection degree between these place names, and the starting place name.

9. The system of ranking place names of claim 8, wherein the place names are a plurality of tourist spots selected from a place name menu.

10. The system of ranking place names of claim 8, wherein the place names are a plurality of tourist spots detected by a browsing module.

11. The system of ranking place names of claim 8, wherein the processing module gets the searching result amounts of place names based on the place names from a local database, wherein each of the place names has one of the searching result amounts of place names respectively.

12. The system of ranking place names of claim 8, wherein the processing module gets the searching result amounts of place names based on the place names from a searching engine, wherein each of the place names has one of the searching result amounts of place names respectively.

13. The system of ranking place names of claim 12, wherein the processing module calculates a plurality of relation factors between every two place names based on the searching result amounts of place names.

14. The system of ranking place names of claim 13, wherein the processing module calculates a plurality of weight factors of the place names based on the relation factors between every two place names and sets the place name corresponding to the greatest one of the weight factors of the place names as the starting place name.

15. The system of ranking place names of claim 14, wherein the processing module calculates a plurality of ranking factors between every two place names based on the relation factors between every two place names, selects the place name corresponding to the greatest one of the ranking factors between every two place names as the next ranked place name respectively, sets the starting place name as a starting point and linking the next ranked place name in turn, calculates a ranking strength factor according to the ranking factors, the relative degree and the intersection degree between every two place names, calculates a plurality of start-end strength factors between the starting place name and one of the other place names according to the ranking factors, the relative degree and the intersection degree therebetween, and sets the starting place name as the starting point and linking the next ranked place name in turn and confirming the order of the place names when the ranking strength factor is greater than the start-end strength factors.

16. A non-transitory computer-readable storage medium, adapted to store a computer program which is utilized to execute a method of ranking place names, the method of ranking place names comprising:
storing a plurality of place names;
getting a plurality of searching result amounts of place names based on these place names;
determining a relative degree between every two place names based on the searching result amounts of the place names;
determining a starting place name of the place name ranking based on the relative degree between every two place names;
calculating the intersection degree between these place names; and
determining the ranking of these place names based on the searching result amounts of the place names, the relative degree between every two place names, the intersection degree between these place names, and the starting place name.
